(19) United States
(12) Patent Application Publication
(10) Pub. No.: US 2023/0200387 A9
(43) Pub. Date: Jun. 29, 2023

(54) HALO ACTIVE AROMATIC SULFONAMIDE ANTIMICROBIAL COMPOSITIONS

(71) Applicant: Rem Brands, Inc., Walton, KY (US)

(72) Inventors: David J. Schneider, Union, KY (US); Jonathan Schneider, Walton, KY (US)

(73) Assignee: Rem Brands, Inc.

(21) Appl. No.: 16/521,212

(22) Filed: Jul. 24, 2019

Related U.S. Application Data
(63) Continuation-in-part of application No. 15/997,892, filed on Jun. 5, 2018, now Pat. No. 10,653,811.
Application No. 15/997,892 is a continuation of application No. 15/019,879, filed on Feb. 9, 2016, now Pat. No. 9,987,389.
Application No. 15/019,879 is a continuation-in-part of application No. 13/105,954, filed on May 12, 2011, now Pat. No. 9,539,446.
(60) Provisional application No. 62/703,751, filed on Jul. 26, 2018.
(60) Provisional application No. 62/113,768, filed on Feb. 9, 2015.
(60) Provisional application No. 61/334,678, filed on May 14, 2010.

(51) Int. Cl. A01N 41/06; C09D 5/14

(52) U.S. Cl. CPC A01N 41/06; C09D 5/14; B65F 1/1415

(57) ABSTRACT

Antimicrobial compositions used to form a residual dry-coat include a halo active aromatic sulfonamide compound of Formula (I):

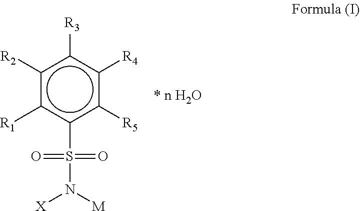

wherein the variables R₁, R₂, R₃, R₄, R₅, X, M and n are disclosed herein. The compositions and processes utilizing the same can be used as a dry coating or layer to maintain disinfected surfaces with reduced microbial count over extended time periods ranging from multiple days up to several weeks.

### CROSS-REFERENCE TO RELATED APPLICATIONS

This application claims priority to U.S. Provisional Patent Application Ser. No. 62/703,751 filed Jul. 26, 2018, the entirety of which is incorporated by reference herein.

### BACKGROUND

The present disclosure relates to disinfecting compositions and processes utilizing the same that can obtain extended microbial killing performance and prophylactic protection over a long period of time (multiple days). The antimicrobial compositions are particularly effective in residual, dry-coated, form. The compositions and associated processes find particular usefulness in settings and environments wherein constant exposure to bacteria and other microorganisms which may cause infection or sickness.

Under certain circumstances, if a patient is in the hospital for a routine procedure and is discharged, then requires subsequent readmittance to the hospital due to a hospital acquired infection (HAI or nosocomial infection), insurance and Medicare may not reimburse the hospital for the costs of the readmittance. Therefore, the hospital must absorb 100% of the cost associated with treatment of the patient until s/he is well again. The estimated annual cost in the United States for HAI's is in the billions of dollars.

In particular, HAIs such as bacterial infections are significant causes of disease and death in the general community and in health-care settings. Vaccines to prevent many bacterial infections are not currently available. The ability to treat bacterial infections with antibiotics is threatened by widespread drug-resistance and the emergence of “super bugs” that are resistant to most currently licensed antibiotics. Effective methods for destroying living bacteria and bacterial endospores (their dormant survival form) are needed to limit the infection of new hosts.

For example, bacteria such as Staphylococcus aureus, Pseudomonas aeruginosa, and Clostridium difficile are responsible for hundreds of thousands of new infections each year in the U.S. They cause thousands of deaths each year, and cost hundreds of millions of dollars annually in health care expenses.

Normal efficacy testing for disinfectants, sterilants, and sanitizers measure performance after a 30-second to 10-minute kill time. These protocols are mandated by various agencies (EPA, AOAC, etc.) to qualify a formulation for registration to claim particular kill performance. However, it is known that products such as bleach, hydrogen peroxide, or peracetic acid are essentially ineffective after they have dried on the surface they are applied to, and have almost no residual kill performance of microorganisms. It would be desirable to provide compositions that have extended killing performance over longer periods of time.

### BRIEF DESCRIPTION

It has been found that certain halo active aromatic sulfonamide compositions, and processes using the same, can provide extended microorganism killing performance on various surfaces to which they are applied. These compositions are particularly effective in evaporated dry-coated or coating applications. In certain circumstances, such residual kill performance can extend for up to one week (seven days, 168 hours), or even two weeks (14 days, 336 hours) or more. In addition, the halo active aromatic sulfonamide compositions are not orally toxic, contact sensitive and/or irritating to the skin, and they do not irritate the eyes.

These and other non-limiting features or characteristics of the present disclosure will be further described below.

### BRIEF DESCRIPTION OF THE DRAWINGS

The following is a brief description of the drawings, which are presented for the purposes of illustrating the exemplary embodiments disclosed herein and not for the purposes of limiting the same.

FIGS. 1A-1F are graphs showing the ATP count on different surfaces over time after application of a certain embodiment of a disinfecting composition of the present disclosure. For all graphs, the y-axis is the ATP count. The x-axis indicates the time measurement.

FIG. 1A is a graph illustrating application on a bedside TV remote control. The y-axis runs from 0 to 5000 in increments of 1000.

FIG. 1B is a graph illustrating application on a children's play table in a waiting room. The y-axis runs from 0 to 8000 in increments of 2000.

FIG. 1C is a graph illustrating application on a patient toilet. The y-axis runs from 0 to 15000 in increments of 5000.

FIG. 1D is a graph illustrating application on a hospital wheelchair armrest. The y-axis runs from 0 to 8000 in increments of 2000.

FIG. 1E is a graph illustrating application on an administration stairway handrail. The y-axis runs from 0 to 6000 in increments of 2000.

FIG. 1F is a graph illustrating application on a men's toilet flush handle. The y-axis runs from 0 to 5000 in increments of 1000.

FIG. 2 is a graph showing the effect of 24-hour exposure of a dry-coated disinfecting composition on S. aureus in accordance with one aspect of the present disclosure.

FIG. 3 is a graph showing the effect of 14-day exposure of a dry-coated disinfecting composition on S. aureus in accordance with another aspect of the present disclosure.

FIG. 4 is a graph showing the effect of a 14-day exposure of a dry-coated disinfecting composition on P. aeruginosa in accordance with a further aspect of the present disclosure.

FIGS. 5A-5C are graphs showing the effect of a dry-coated disinfecting composition on three strains of C. difficile in accordance with still another aspect of the present disclosure.

FIG. 6A is a perspective view of a conventional trash bag on which a dry disinfectant coating can be formed.

FIG. 6B is a cross-sectional view of a sidewall of the trash bag of FIG. 6A.

### DETAILED DESCRIPTION

A more complete understanding of the components, processes, and apparatuses disclosed herein can be obtained by reference to the accompanying drawings. These figures are merely schematic representations based on convenience and the ease of demonstrating the present disclosure, and are, therefore, not intended to indicate relative size and dimensions of the devices or components thereof and/or to define or limit the scope of the exemplary embodiments.

Although specific terms are used in the following description for the sake of clarity, these terms are intended to refer only to the particular structure of the embodiments selected for illustration in the drawings, and are not intended to define or limit the scope of the disclosure. In the drawings and the following description below, it is to be understood that like numeric designations refer to components of like function.

### Definitions

The singular forms “a,” “an,” and “the” include plural referents unless the context clearly dictates otherwise.

As used in the specification and in the claims, the term “comprising” may include the embodiments “consisting of” and “consisting essentially of.” The terms “comprise(s),” “include(s),” “having,” “has,” “can,” “contain(s),” and variants thereof, as used herein, are intended to be open-ended transitional phrases, terms, or words that require the presence of the named ingredients/steps and permit the presence of other ingredients/steps. However, such description should be construed as also describing compositions or processes as “consisting of” and “consisting essentially of” the enumerated ingredients/steps, which allows the presence of only the named ingredients/steps, along with any impurities that might result therefrom, and excludes other ingredients/steps.

Numerical values in the specification and claims of this application should be understood to include numerical values which are the same when reduced to the same number of significant figures and numerical values which differ from the stated value by less than the experimental error of conventional measurement technique of the type described in the present application to determine the value.

All ranges disclosed herein are inclusive of the recited endpoint and independently combinable (for example, the range of “from 2 to 10” is inclusive of the endpoints, 2 and 10, and all the intermediate values).

The term “about” can be used to include any numerical value that can vary without changing the basic function of that value. When used with a range, “about” also discloses the range defined by the absolute values of the two endpoints, e.g. “about 2 to about 4” also discloses the range “from 2 to 4.” The term “about” may refer to plus or minus 10% of the indicated number.

The term “ambient temperature” refers to a temperature of 20° C. to 25° C.

Compounds are described using standard nomenclature. For example, any position not substituted by any indicated group is understood to have its valency filled by a bond as indicated, or a hydrogen atom. A dash (“-”) that is not between two letters or symbols is used to indicate a point of attachment for a substituent. For example, the aldehyde group —CHO is attached through the carbon of the carbonyl group.

The term “alkyl” refers to a radical composed entirely of carbon atoms and hydrogen atoms which is fully saturated. The alkyl radical may be linear, branched, or cyclic, and such radicals may be referred to as linear alkyl, branched alkyl, or cycloalkyl.

The term “aromatic” refers to a radical that has a ring system containing a delocalized conjugated pi system with a number of pi-electrons that obeys Hückel's Rule. The ring system may include heteroatoms (e.g. N, S, Se, Si, O), or may be composed exclusively of carbon and hydrogen. Exemplary aromatic groups include phenyl, thienyl, naphthyl, and biphenyl.

The term “aryl” refers to an aromatic radical composed exclusively of carbon and hydrogen. Exemplary aryl groups include phenyl, naphthyl, and biphenyl.

The term “heteroaryl” refers to an aromatic radical containing at least one heteroatom. Exemplary heteroaryl groups include thienyl. Note that “heteroaryl” is a subset of “aromatic”, and is exclusive of “aryl”.

The term “alkoxy” refers to an alkyl radical which is attached to an oxygen atom, i.e. —O—CₙH₂ₙ₊₁, to a molecule containing such a radical.

The term “halogen” refers to fluorine, chlorine, bromine, and iodine.

The term “substituted” refers to at least one hydrogen atom on the named radical being substituted with another functional group, such as halogen, —CN, or —NO₂. Besides the aforementioned functional groups, an aromatic group may also be substituted with alkyl or alkoxy. An exemplary substituted aryl group is methylphenyl.

The term “alkali metal” refers to lithium, sodium, and potassium.

The term “alkaline earth metal” refers to magnesium and calcium.

As used herein, the term “antimicrobial” means an agent that will kill or inhibit the growth of microorganisms, such as, for example, bacteria, viruses, and fungi.

As used herein, the term “disinfect” means to inactivate, kill, or otherwise render non-pathogenic a pathogen, such as, for example, a bacteria, virus, for fungus.

As used herein, the term “killing performance” refers to the ability of a composition to inactivate, kill, or otherwise render non-pathogenic a microorganism, and may be measured as a function of the reduction in viability of a particular microorganism. The term “killing performance” may also have a time/duration dimension (i.e. killing performance at 24 hours, 48 hours, 72 hours, etc.).

The term “film” or layer” or “coating” refers to a covering upon the surface of an object (also called a substrate). The film or layer or coating may cover the entire surface, or just a portion of the surface.

The term “dry” is used to refer to the film or layer or coating containing so little solvent that it does not flow when in the steady state.

The term “gel” refers to the film or layer or coating being cross-linked and not flowing when in the steady state.

Staphylococcus aureus (i.e. S. aureus) is a gram-positive bacteria commonly found on skin and in the nasopharynx. It can infect any human tissue, invade the body, and cause death. It is a leading cause of bacterial infections and death due to bacterial infections. Antibiotic treatment of S. aureus infection is complicated by widespread drug-resistance (MRSA, VRSA).

Pseudomonas aeruginosa (i.e. P. aeruginosa) is a gram-negative bacteria found throughout the natural and health care environment. It can infect any human tissue, invade the body, and cause death. It is a leading cause of bacterial infections and death in the immunocompromised, especially in cancer and burn patients. Antibiotic treatment of P. aeruginosa infection is complicated by widespread drug-resistance.

Clostridium difficile (i.e. C. difficile) is a spore-forming gram-positive bacteria that is highly prevalent in the environment. It is a common cause of antibiotic-associated diarrhea and may cause life-threatening infections. The spores of C. difficile survive long-term in the environment and contaminate many surfaces in hospital environments. C. difficile is anaerobic, grows only where there is no oxygen, and cannot survive outside the body as a living cell, therefore it forms bacterial endospores. C. difficile endospores are highly resistant to disinfectants and various forms of radiation, and can persist for years on surfaces. Antibiotic treatments for C. difficile infection are complicated by endospore formation in the body, as the dormant endospores are not affected by antibiotics. Effective methods for destroying bacterial endospores need to be developed to limit the infection of new hosts.

Compositions

Halo active aromatic sulfonamide organic compounds have been known to reduce or eliminate odor. Chloramine-T is an example of a sulfonamide organic compound which has been used in many applications. The usefulness of Chloramine-T is predicated on its ability to release an active chloride ion when needed on demand, immediately after which it simultaneously generates an active aromatic sulfo nitrene companion ion. The chlorine atom has a +1 formal charge in a hypochlorite ion, ClO⁻, which is the form taken by the chlorine atom when dissociated from the sulfonamide compound. Reference to the chlorine atom as having a +1 or 1⁻ charge may be used in this application interchangeably because this terminology has no effect on the compound itself or its use.

It has been found in the present disclosure that halo active aromatic sulfonamide organic compounds also have an antimicrobial performance that can extend over long periods of time, particularly in residual, or dry-coated, form. This may be useful in any setting where large numbers of people congregate, particularly sick people. This can include commercial, industrial, governmental, and other institutional facilities, including places such as a hospital, nursing home or long term care facility, school, jail or prison, an airport, a vehicle, a watercraft, an airplane, a house, a gym or workout facility, or a supermarket. Whereas common disinfectants such as bleach, hydrogen peroxide, or peracetic acid are typically applied to a surface and then dry/evaporate within minutes, ending their disinfectant ability, it has been found that hydrates of halo active aromatic sulfonamide organic compounds will continue to exhibit disinfectant ability over long time periods, such as over 24 hours, over 48 hours, over 72 hours, over 168 hours, or even as long as 336 hours (two weeks), or longer. It is believed that these compounds can also maintain disinfectant ability for longer periods, such as months or even years, so long as the active aromatic sulfonamide organic compound is present on the surface and has not been exhausted or decomposed. For example, the disinfectant ability may be maintained for at least 1 month, at least 2 months, at least 3 months, at least 4 months, at least 5 months, at least 6 months, at least 7 months, at least 8 months, at least 9 months, at least 10 months, at least 11 months, or at least 12 months, or more.

The halo active aromatic sulfonamide organic compounds also have several usage benefits over traditional disinfectants such as bleach or hydrogen peroxide. For example, bleach has a very strong chlorine odor in open air and during cleaning; is rapidly destructive for many surface types; only reduces microbes when wet, and has essentially no residual antimicrobial action once dry; has poor stability in “non-ambient” temperatures and light exposure; and is toxic, a skin and eye irritant, and a skin sensitizer. In contrast, compositions using halo active aromatic sulfonamide organic compounds can have equivalent antimicrobial performance, but also have long term residual antimicrobial action when dried on a surface; offer residual odor elimination when dry; have excellent stability, with a shelf life measured in years; and have extremely low toxicity, are not skin/eye irritating, and are not a sensitizer.

The disinfecting compositions of the present disclosure comprise (A) a halo active aromatic sulfonamide compound, as described further herein. The compositions can also include (B) water; (C) a buffering agent; (D) a surfactant; (E) a tracer fragrance; and/or (F) alcohol, in any combination, and preferably, of two or more of these additional ingredients. Additionally, the disinfecting/antimicrobial compositions may be evaporative, meaning that a portion of the composition evaporates to leave a residual antimicrobial/disinfecting coating (i.e. a dry-coated film) that can maintain a suitable killing performance for extended periods of time.

The halo active aromatic sulfonamide compound used in the disinfecting compositions of the present disclosure has the structure of base Formula (I):

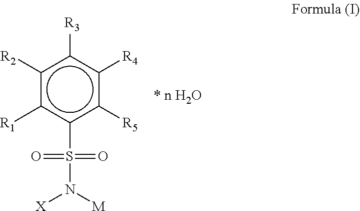

wherein R₁, R₂, R₃, R₄, and R₅ are independently selected from hydrogen, COOR′, CON(R″)₂, alkoxy, CN, NO₂, SO₃R″, halogen, substituted or unsubstituted phenyl, sulfonamide, halosulfonamide, N(R″)₂, substituted or unsubstituted C₁-C₁₂ alkyl, and substituted or unsubstituted aromatic;

R′ is hydrogen, an alkali metal, an alkaline earth metal, substituted C₁-C₁₂ alkyl, or unsubstituted C₁-C₁₂ alkyl; and

R″ is hydrogen or substituted or unsubstituted C₁-C₁₂ alkyl, where the two R″ groups in CON(R″)₂ and N(R″)₂ may be independently selected;

X is halogen;

M is an alkali or alkaline earth metal; and

n is the number of water molecules per molecule of the sulfonamide compound.

The term “aromatic”, as used herein, does not refer to a smell detected by the nose.

Generally, M is sodium or potassium. X is generally chlorine, bromine, fluorine, or iodine, and in particular embodiments is chlorine. Compounds of Formula (I) may or may not be hydrated, as indicated by the variable n. In particular embodiments, the compounds of Formula (I) are a trihydrate (i.e., n=3) or a hexahydrate (i.e. n=6). In other embodiments, the compound is in a solid form, such as a powder.

When the phenyl and/or alkyl group is substituted, one or more hydrogen atoms may be independently replaced with hydroxyl or halogen.

In particular embodiments of Formula (I), R₃ is methyl, COOH, or COOM₁; R₁, R₂, R₄, and R₅ are independently selected from hydrogen, COOH, COOM₁, COOR′, CON(R″)₂, alkoxy, CN, NO₂, SO₃R″, halogen, substituted or unsubstituted phenyl, sulfonamide, halosulfonamide, N(R″)₂, substituted or unsubstituted C₁-C₁₂ alkyl, and substituted or unsubstituted aromatic; X is halogen; M₁ is an alkali or alkaline earth metal; and n is the number of water molecules per molecule of the sulfonamide compound.

In further embodiments, R₃ is methyl, COOH, or COOM₁; R₁, R₂, R₄, and R₅ are independently selected from hydrogen, COOH, COOM₁, COOR′, CON(R″)₂, alkoxy, CN, NO₂, SO₃R″, halogen, substituted or unsubstituted phenyl, sulfonamide, halosulfonamide, N(R″)₂, substituted or unsubstituted C₁-C₁₂ alkyl, and substituted or unsubstituted aromatic; X is halogen; M is an alkali or alkaline earth metal; n is the number of water molecules per molecule of the sulfonamide compound; and at least one of R₁, R₂, R₄, and R₅ is not hydrogen.

In yet other embodiments of Formula (I), R₃ is selected from COOH, COOM₁, COOR′, CON(R″)₂, CN, NO₂, halogen, and substituted or unsubstituted C₂-C₁₂ alkyl; R₁, R₂, R₄, and R₅ are independently selected from hydrogen, COOH, COOM₁, COOR′, CON(R″)₂, alkoxy, CN, NO₂, SO₃R″, halogen, substituted or unsubstituted phenyl, sulfonamide, halosulfonamide, N(R″)₂, substituted or unsubstituted C₁-C₁₂ alkyl, and substituted or unsubstituted aromatic; X is halogen; M is an alkali or alkaline earth metal; and n is the number of water molecules per molecule of the sulfonamide compound.

In still other embodiments of Formula (I), R₁, R₂, R₃, R₄, and R₅ are independently selected from hydrogen, COOH, COOM₁, NO₂, halogen, N(R″)₂, substituted or unsubstituted C₁-C₁₂ alkyl, and substituted or unsubstituted aromatic; X is halogen; M is an alkali or alkaline earth metal; and n is the number of water molecules per molecule of the sulfonamide compound.

In yet other embodiments of Formula (I), R₂ and R₄ are identical to each other; and R₁, R₃, and R₅ are hydrogen.

In yet other embodiments of Formula (I), R₂ and R₄ are hydrogen; and R₁, R₃, and R₅ are identical to each other.

In more specific embodiments of Formula (I), R₃ is selected from COOH, COOM₁, COOR′, and CON(R″)₂. Most desirably, R₃ is COOH or COOM₁, while R₁, R₂, R₄, and R₅ are hydrogen.

In other embodiments of Formula (I), R₁, R₂, R₃, R₄, and R₅ are independently selected from hydrogen, COOH, COOM₁, COOR′, CON(R″)₂, NO₂, halogen, N(R″)₂, substituted or unsubstituted C₁-C₁₂ alkyl, and substituted or unsubstituted aromatic; wherein at least one of R₁, R₂, R₃, R₄, and R₅ is not hydrogen; X is halogen; M is an alkali or alkaline earth metal; and n is the number of water molecules per molecule of the sulfonamide compound.

In still other embodiments of Formula (I), R₃ is COOH or COOM₁; R₁, R₂, R₄, and R₅ are independently selected from hydrogen, NO₂, halogen, N(R″)₂, substituted or unsubstituted C₁-C₁₂ alkyl, and substituted or unsubstituted aromatic; X is halogen; M is an alkali or alkaline earth metal; and n is the number of water molecules per molecule of the sulfonamide compound. In further specific embodiments, at least one of R₁, R₂, R₄, and R₅ is not hydrogen.

In some embodiments of Formula (I), at least one of R₁, R₂, R₃, R₄, or R₅ are not hydrogen. In more specific embodiments of Formula (I), at least two of R₁, R₂, R₃, R₄, or R₅ are not hydrogen. In other words, the benzene ring contains the sulfonamide substituent and an additional one or two other substituents.

In other embodiments of Formula (I), the halo active aromatic sulfonamide compound has the structure of Formula (II):

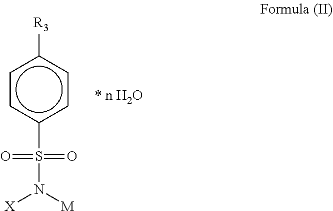

wherein R₃ is COOR′; R′ is hydrogen, an alkali metal, an alkaline earth metal, substituted C₁-C₁₂ alkyl, unsubstituted C₁-C₁₂ alkyl, substituted aromatic, or unsubstituted aromatic;

X is halogen; M is an alkali or alkaline earth metal; and n is the number of water molecules per molecule of the sulfonamide compound. The N-chloro-4-carboxybenzenesulfonamide compound of Formula (II) is also referred to herein as BENZ. BENZ exhibits a lower chlorine smell than chloramine-T or chloramine-B. When BENZ is combined with at least one fragrance, there is no detectable chlorine smell for most humans.

Two particular sulfonamide compounds contemplated for use are N-chloro-p-toluenesulfonamide (i.e. chloramine-T) and N-chloro-4-carboxybenzenesulfonamide (i.e. BENZ). These two compounds are shown below as Formulas (III) and (IV):

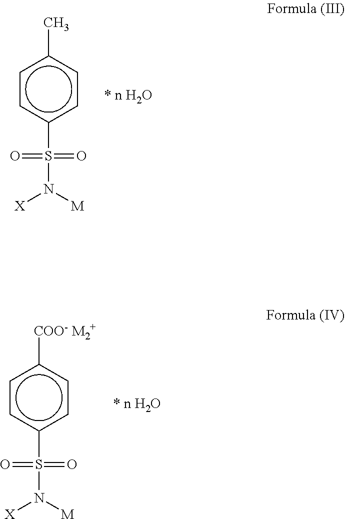

wherein M₂ is hydrogen, an alkali metal, or an alkali earth metal; X is halogen, M is independently an alkali or alkaline earth metal; and n is the number of water molecules per molecule of each sulfonamide compound. Desirably, M₂ is hydrogen, sodium, or potassium.

In other particular embodiments, one or more of R₁, R₂, R₃, R₄, and R₅ are substituted with —COOR′ (and the others are hydrogen). In this regard, it is believed that when the halo active aromatic sulfonamide compound has two or more ionic charges, that the compound has higher antimicrobial performance. The antimicrobial performance of these compounds of Formula (I) was not expected, because sulfonamide groups having a halogen atom bonded to the nitrogen atom are not present in molecules having known antimicrobial properties.

The halo active aromatic sulfonamide compounds of base Formula (I) are stable and do not decompose in aqueous solution, allowing the disinfecting composition to have a long shelf life. The compounds of Formula (I) are also very soluble in water, low in toxicity, and have minimal bleach odor.

The halo active aromatic sulfonamide compound (A) is generally present in the disinfecting composition in the amount of about 0.0001 wt % to about 5 wt %. When used to form a dry residual layer, coating, film, or gel on a surface (i.e. after evaporation/drying), the halo active aromatic sulfonamide compound (A) may be up to about 100 wt % of the dry material, including from about 0.0001 wt % to nearly about 100 wt % of the dry material. The water (B), which acts as a carrier vehicle for applying the halo active aromatic sulfonamide compound to hard or soft surfaces, generally makes up the majority of the remaining disinfecting composition.

For stability and for optimum performance, the pH of the disinfecting composition should be between 5 and 14, though generally the pH should be kept between 8 and 14, or between 6 and 10, or between 6.5 and 9, or between 7 and 9, or between 7 and 8.5, or between 8 and 9. A buffering agent (C) can be included to maintain the solution within these pH ranges. Exemplary buffering agents include sodium bicarbonate, potassium bicarbonate, sodium carbonate, potassium carbonate, acetate buffers (such as sodium acetate), phosphate buffers (such as tri and di sodium phosphate and mixtures thereof, pH blended phosphates, sulfate buffers (such as di and tri sodium sulfate), and mixtures thereof. The buffering agent can be added up to the limit of solubility in the disinfecting compositions. In particular embodiments, the preferred weight ratio of the sulfonamide compound to the buffering agent is from about 1000:1 to about 1:1, or from about 500:1 to about 2:1, or from about 100:1 to about 2:1, or from about 50:1 to about 1:1, or from about 50:1 to about 2:1, or from about 20:1 to about 2:1. The preferred buffering agent is sodium bicarbonate.

In preferred embodiments, the disinfecting composition can comprise from about 0.01 wt % to about 2 wt % of the halo active aromatic sulfonamide compound (A), or from about 0.1 wt % to about 1 wt % of the halo active aromatic sulfonamide compound (A). In some embodiments, the disinfecting composition can comprise a buffering agent (C) and have a pH of from about 6.5 to about 9, or from about 7 to about 8.5.

In further preferred embodiments, the residual dry-coat formed from the disinfecting composition can comprise at least 5 wt % of the halo active aromatic sulfonamide compound (A), or at least 10 wt % of the halo active aromatic sulfonamide compound (A), or at least 25 wt % of the halo active aromatic sulfonamide compound (A), or at least 50 wt % of the halo active aromatic sulfonamide compound (A), or at least 51 wt % of the halo active aromatic sulfonamide compound (A), or at least 75 wt % of the halo active aromatic sulfonamide compound (A), or at least 80 wt % of the halo active aromatic sulfonamide compound (A), or at least 90 wt % of the halo active aromatic sulfonamide compound (A), or at least 95 wt % of the halo active aromatic sulfonamide compound (A), or at least 99 wt % of the halo active aromatic sulfonamide compound (A).

In certain embodiments, the disinfecting composition used to form the residual dry-coat may comprise about 1 wt % of the halo active aromatic sulfonamide compound (A) and at least 1 wt % of the buffering agent (C), including about 1 wt % of the halo active aromatic sulfonamide compound (A) and from about 1 wt % to about 5 wt % of the buffering agent (C). The halo active sulfonamide compound (A) may be, for example, a N-chloro-4-carboxybenzenesulfonamide compound of Formula (II):

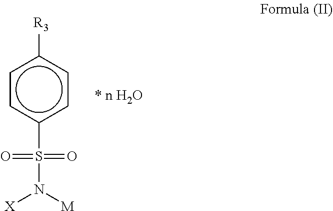

wherein R₃ is COOR′; R′ is hydrogen, an alkali metal, an alkaline earth metal, substituted C₁-C₁₂ alkyl, unsubstituted C₁-C₁₂ alkyl, substituted aromatic, or unsubstituted aromatic; X is halogen; M is an alkali or alkaline earth metal; and n is the number of water molecules per molecule of the sulfonamide compound.

A surfactant (D), or wetting agent, can also be added to the disinfecting composition. The surfactant decreases surface tension, allowing the sulfonamide compound to be spread more widely upon the surface to which it is applied. Both non-ionic and anionic surfactants can be used. However, in some specific embodiments, a surfactant is not used. The surfactant (D) can be present in the disinfecting composition in the amount of about 0.0001 wt % to about 5 wt %.

A tracer fragrance (E) can also be included in the disinfecting composition if desired. The tracer fragrance helps the user know where s/he has applied the disinfecting composition. Such tracer fragrances typically evaporate rapidly upon application, generally in under a minute. The tracer fragrance can be present in the disinfecting composition in the amount of about 0.0001 wt % to about 5 wt %.

Additionally, an alcohol (F) component can be included in the disinfecting compositions if desired. The alcohol may be useful for changing surface tension, to solubilize fragrances, obtain a favorable odor profile, and obtain a quicker drying time.

In particular embodiments, the disinfecting composition may be an evaporative disinfecting composition. That is, the disinfecting composition may evaporate/dry over a short period of time to form a residual disinfectant coating (e.g. on a surface). A residual disinfectant coating may be formed from a disinfecting composition as described herein and maintains antimicrobial properties for an extended period of time after application of the disinfecting composition and drying of the disinfecting composition. The residual dry coating/layer contains the halo active aromatic sulfonamide organic compound. The residual layer has a thickness that may vary as desired by the user.

While not being limited by theory, it is believed that minor amounts of water, either through the hydrated nature active sulfonamide compound and/or the ambient humidity, will keep the sulfonamide active over an extended period of time compared to other products such as bleach. Thus, the antimicrobial kill performance of the sulfonamide will extend over that time period as well, so that new applications of microorganisms will also be eliminated, even after drying. Extended kill and prophylactic protection of surfaces is thus possible for times of up to 2 weeks, one month, multiple months, or one year, or even multiple years as previously described herein, as long as the sulfonamide compound is not exhausted or decomposed or degraded. Such performance is not obtained by other disinfectants such as bleach, even when they are rewetted. Put another way, known products (bleach, peroxide) generally only kill microorganisms while they are wet, and their killing ability essentially ends after they have dried. Such products provide little, if any, residual protection: if new microorganisms are applied to the surface after the product has dried, those new microorganisms will survive and reproduce. This lack of residual protection by known products is substantially different from the compositions presently disclosed herein.

Methods

Also disclosed herein are methods and processes of disinfecting surfaces for an extended periods of time using the antimicrobial compositions described above. In particular embodiments, the methods comprise applying an antimicrobial composition to a surface, wherein the antimicrobial composition comprises a halo active aromatic sulfonamide compound.

The disinfecting compositions can protect a variety of hard or soft surfaces, including but not limited to: metals, stainless steel, leather, gypsum board and drywall, painted surfaces, toilets, sinks, faucets, countertops, bedrails, beds, linens, light switches, hospital and other touchpoint surfaces, remotes, keyboard, cellphone, phones, communication devices, walls, toys, cushions, electronic buttons such as in elevators, money and currency, exercise equipment, rehabilitation equipment, paper, upholstery, and food preparation materials and equipment. Hard surfaces can include those on desks, tables, chairs, beds, walls, windows, handles, floors, ceilings, toilets, sinks, electronic devices, handrails, etc. Soft surfaces can include those on plastics (i.e. polymers), window coverings (drapes, curtains, blinds, etc.), and the like. Generally, a hard surface is one that cannot be bent by a person with their unassisted bare hands, whereas a soft surface can be bent or is flexible to some degree. Additionally, the disinfecting compositions and residual dry coatings formed from the disinfecting compositions may be used on skin (e.g. human and/or animal skin).

The disinfecting compositions are contemplated to be especially useful in settings where large numbers of people may pass through. Such settings can include, for example, a hospital, nursing home or long term care facility, school, jail or prison, a vehicle (e.g. automobile, train, airplane, bus, livery vehicle, etc.), a house, a public facility (airport, hotel, restaurant, restroom, etc.), a gym or workout facility, or a supermarket, or similar settings, just as a limited number of examples.

In particular embodiments, the disinfecting compositions can be applied to surfaces by spraying, electrostatic application, fogging, wipes, misting, or immersion, amongst other applications. In other embodiments, the disinfecting compositions can be combined (e.g. mixed) with a secondary material and then applied to a surface along with the secondary material.

In further embodiments, the method may comprise forming a residual dry-coating on the intended surface. For example, the disinfecting compositions may be applied to the surface(s) in a wet form and allowed to evaporate over a period of time, thereby forming a residual dry-coat on the surface(s). In some embodiments, the intended surface may be skin, such as the skin of a human and/or animal.

The disinfecting compositions may also be applied to a surface or surfaces of an article during the manufacturing of the article. For example, the disinfecting composition may be impregnated into or otherwise applied to a surface of an article during the manufacturing process. For example, the halo active aromatic sulfonamide can be impregnated into articles including but not limited to: gypsum board and drywall, personal items such as toothpaste or mouthwash, building materials for commercial, industrial, and residential industry, toys, money and currency, paper, ink, sports equipment (not clothing), packaging materials, food preparation materials and equipment, and hard and soft surfaces.

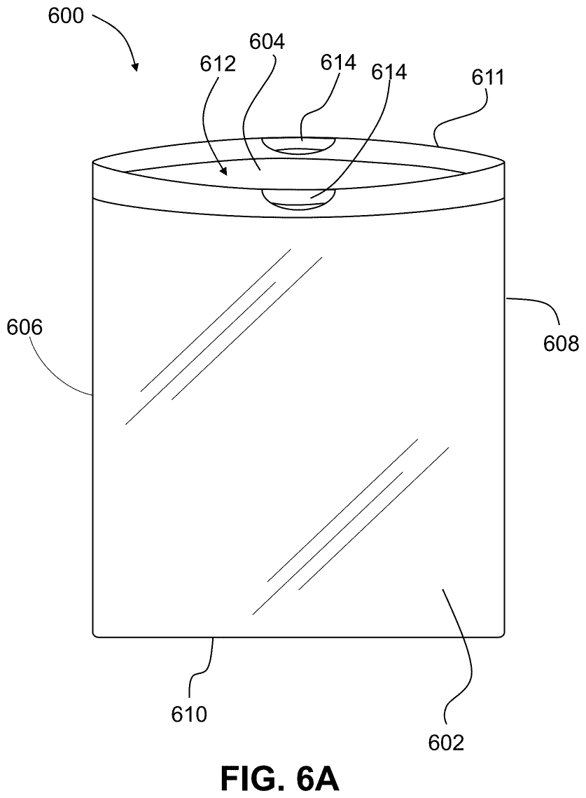

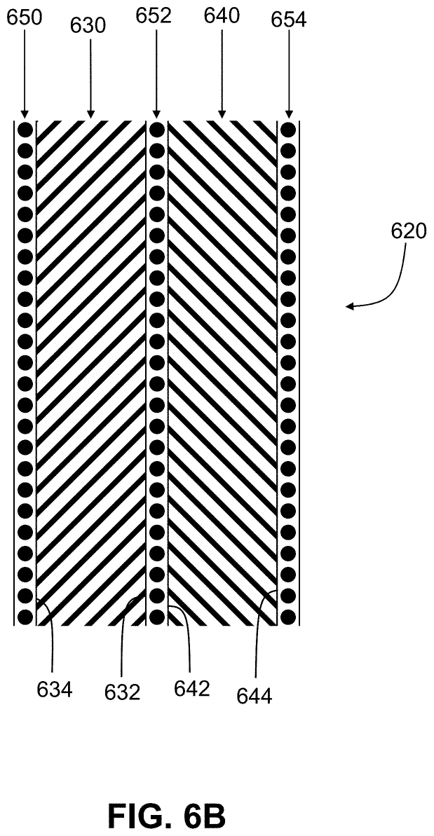

In particular embodiments, it is contemplated that the article is a bag, particularly a polymeric trash bag. FIG. 6A is a perspective view of a multi-layer trash bag.

The trash bag 600 includes a first sidewall 602 and a second sidewall 604. The two sidewalls 602, 604 are joined together along a first side edge 606, a second side edge 608 opposite the first side edge, and a bottom edge 610 extending between the first and second side edges 606, 608. The bag has a top edge 611 opposite the bottom edge which is not sealed, and when the bag is expanded, an opening 612 is formed through which items are thrown into the internal volume of the trash bag. The sealed edges 606, 608, 610 can be made by, for example, heat sealing two separate multi-layer films together along all three edges 606, 608, 610. Alternatively, a single large multi-layer film could be folded in half (the fold line corresponding to bottom edge 610) and the two side edges could be sealed together. Along the top edge 611 is a draw tape 614 that acts as a closure mechanism for the trash bag, and which is visible through apertures along the top edge.

FIG. 6B is a cross-sectional view of one of the sidewalls of the trash bag of FIG. 6A. As previously mentioned, the sidewall 620 is formed from a multi-layer film. Here, the sidewall 620 is illustrated as having a first film layer 630 and a second film layer 640 (of course, the multi-layer film can contain additional layers). The first film layer 630 has an interior surface 632 and an exterior surface 634. The second film layer 640 also has an interior surface 642 and an exterior surface 644. The interior surfaces 632, 642 of the two film layers face each other, and are laminated together. The exterior surface 634 of the first film layer faces the internal volume of the trash bag, while the exterior surface 644 of the second film layer also forms the outer surface of the trash bag itself. The two film layers may have thicknesses as desired. The first film layer 630 may be relatively permeable to gases and liquids. It is contemplated that the dry disinfectant coating/layer could be located in multiple locations. First, the dry disinfectant coating could be located on the exterior surface 634 of the first film layer, or in other words on the inner surface of the trash bag (indicated with reference numeral 650). Second, the dry disinfectant coating could be located on one of the interior surfaces 632, 642 of the film layers, or in other words between the two film layers 630, 640 of the trash bag (indicated with reference numeral 652). Third, the dry disinfectant coating could be located on the exterior surface 644 of the second film layer, or in other words on the outer surface of the trash bag (indicated with reference numeral 654). The dry disinfectant coating/layer may be uniformly formed across the entire film layer, or preferentially formed in desired locations such as along the top edge/opening of the trash bag. The dry disinfectant coating may be formed at any one or combination of these locations. In whatever location, it is contemplated the dry disinfectant coating/layer containing the halo active aromatic sulfonamide compound can be exposed to water (e.g. permeating through the film layer) that hydrates the sulfonamide compound and permits its active antimicrobial ability.

In accordance with several aspects of the methods described, the treated surface may maintain antimicrobial effect for over 24 hours, or over 48 hours, or over 72 hours, or over 168 hours, or over 336 hours, or longer.

The disinfecting compositions of the present disclosure may achieve high microbial killing performance over extended periods of time. In particular embodiments, the disinfecting composition can maintain a killing performance after drying (i.e. in residual dry-coat form) of at least 85% after 24 hours, or at least 90% after 24 hours, or at least 95% after 24 hours, or at least 98% after 24 hours, or at least 85% after 48 hours, or at least 90% after 48 hours, or at least 95% after 48 hours, or at least 98% after 48 hours, or at least 85% after 72 hours, or at least 90% after 72 hours, or at least 95% after 72 hours, or at least 98% after 72 hours, or at least 85% after 168 hours, or at least 90% after 168 hours, or at least 95% after 168 hours, or at least 98% after 168 hours, or at least 85% after 336 hours, or at least 90% after 336 hours, or at least 95% after 336 hours, or at least 98% after 336 hours.

The disinfecting compositions of the present disclosure are illustrated by the following non-limiting examples, it being understood that these examples are intended to be illustrative only and that the present application is not intended to be limited to the materials, conditions, process parameters and the like recited herein. All proportions are by weight unless otherwise indicated.

### EXAMPLES

### Example 1

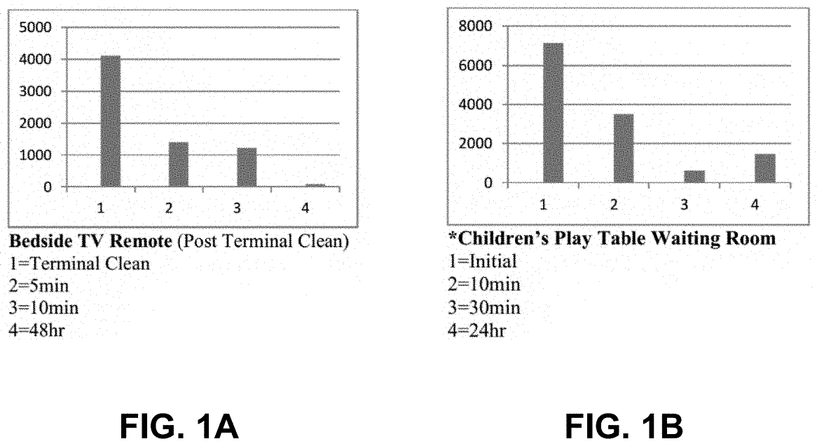

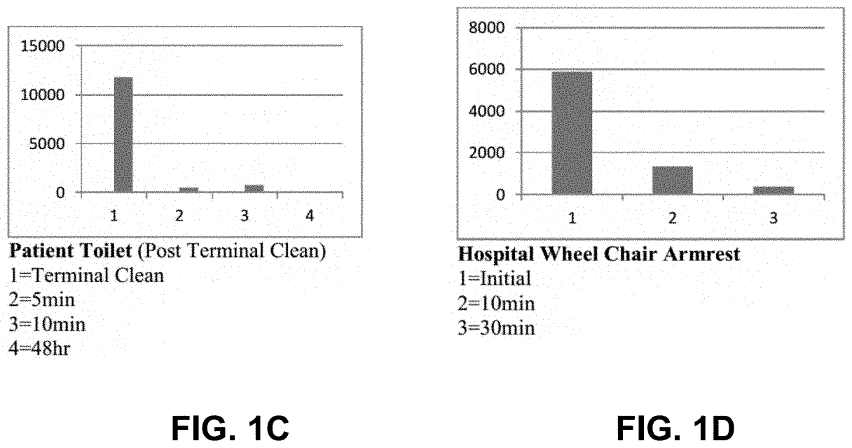

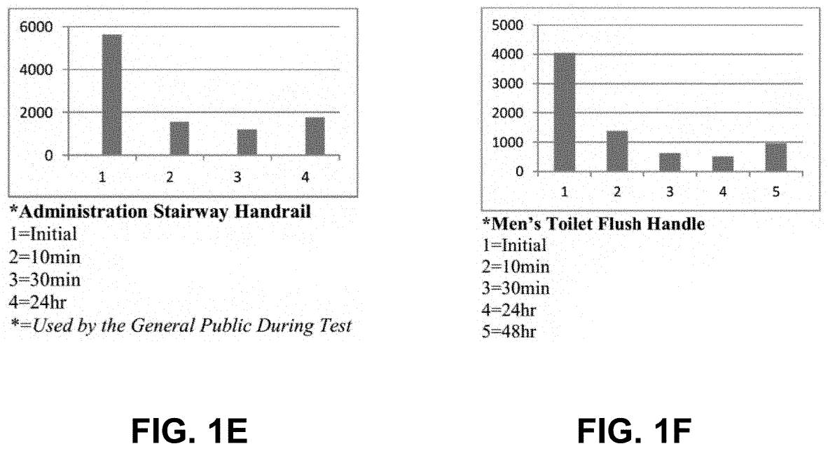

Experiments were conducted on the infectious disease floor of a hospital. After terminal clean, swab tests were conducted to provide a baseline. Then a composition containing BENZ was applied via an electrostatic sprayer to various surfaces in the room that were target areas to test. The composition contained 0.9 wt % BENZ and included water, surfactant, and tracer fragrance. Over time, swabs were taken and tested using the ATP method, which measures microorganism growth by detection of ATP. The results are seen in FIGS. 1A-1F. For reference, ATP counts should be below 200 to be acceptable, and counts over 300 indicate high levels of microbial growth.

Initially, the post terminal clean readings were very high. There are several possible reasons. One, the surface could have been missed by terminal cleaning staff. Two, the surface could have been re-contaminated by the surroundings, nurses' gloves, HVAC systems, etc. However, regardless of the reason, the application of the composition took the ATP counts down to much lower levels, and maintained those low levels for up to 48 hours (depending on the surface, not all surfaces measured for 48 hours). This indicated that disinfecting composition with BENZ had a protection mechanism that is vastly different than traditional disinfection methods, and could protect for longer time periods than with conventional disinfection methods.

### Example 2

### Extended Dry-Coat Testing with S. aureus and P. aeruginosa

The ability of the disinfecting compositions to remain active after drying for an extended period of time was tested using a dry-coating method.

Disinfecting compositions containing 1 wt %, 0.5 wt %, 0.25 wt %, 0.1 wt %, 0.05 wt %, and 0.025 wt % of N-chloro-4-carboxybenzenesulfonamide (BENZ), and a vehicle control solution were prepared. Approximately 5 mL of each solution was added to a sterile polystyrene petri dish, completely covering the surface, and allowed to evaporate and dry coat the plate surface overnight. After drying, the coated plates were stored at room temperature.

At several time points after drying (24 hours, 7 days, and 14 days), bacterial solutions were added as 25 μl drops at several locations on each plate. Bacterial solutions of S. aureus and P. aeruginosa (laboratory stocks purchased from ATCC) were prepared from 24-48 hour freshly grown bacterial monolayers on Tryptic Soy Agar (TSA) plates. The bacterial monolayer was removed from the plate surface with a sterile loop and transferred to 10 ml sterile saline. The resulting solutions were visibly turbid and by comparison to McFarlan standards estimated to contain between 1×10⁸ to 1×10⁹ bacteria per ml. Thus, 25 μl drops corresponding to about 5×10⁶ total bacteria were added at several replicate locations on each plate.

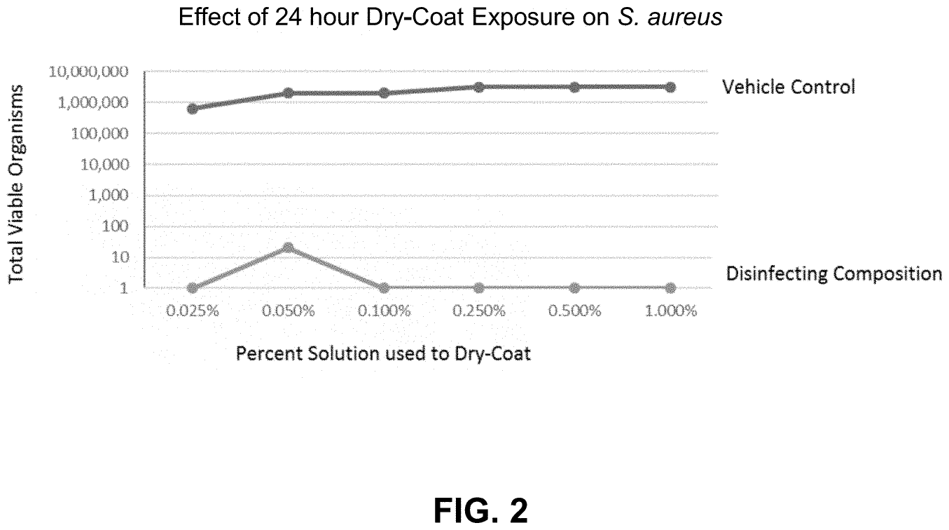

To determine the number of bacteria killed by exposure to the disinfecting composition, the bacterial spots were swabbed off of the plate surface with a sterile moistened cotton swab and diluted in 2 ml sterile saline. A 96-well dilution plate was used to prepare an end-point dilution series to determine the number of recoverable bacteria. Each dilution well was filled with 720 μL of tryptic soy broth (TSB). An 80 μL sample was taken from each swab sample tube and placed in the top dilution well. A 1:10 (80 μL: 800 μL) dilution series was performed down the plate with 80 μL samples being transferred down the plate. A 100 μL sample from the top well of each column was taken and plated on TSA for colony counts. Plates were incubated at 37° C. for 48 hours. A plus-minus system was assigned at the presence or absence of viable bacterial pellets in the 96-well dilution plate and colony counts were used to confirm the results. End-point dilution scores from the dilution plates used for S. aureus and P. aeruginosa were converted to total viable cell counts using the Spearman-Karber Equation. The limits of detection for this assay design were 20 bacteria. The results are seen in FIGS. 2-4.

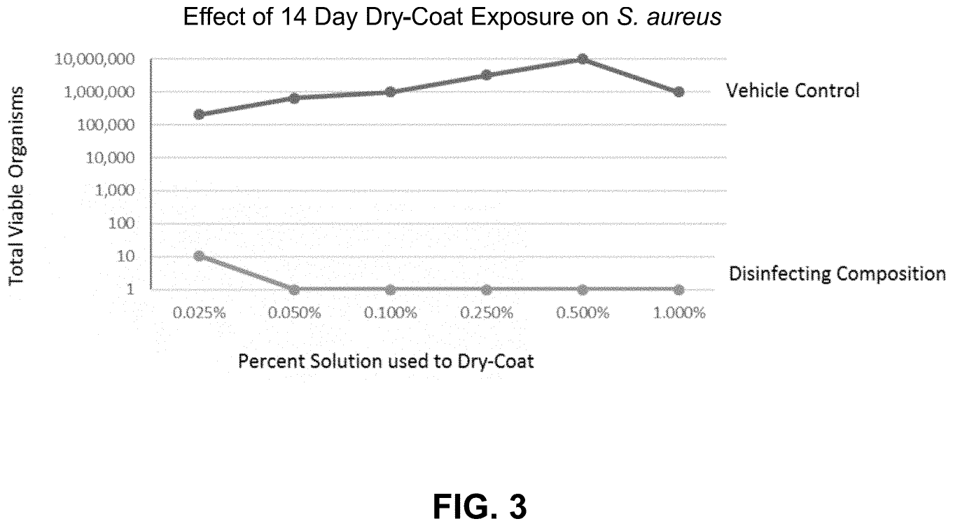

Regarding FIG. 2 and FIG. 3, the test results with respect to S. aureus are shown after 24 hours and 14 days of exposure to the dry-coat disinfecting compositions. The average amount of live bacteria from two technical replicate titrations of 2-3 biological/experimental replicates are illustrated. At all tested concentrations of the disinfecting composition, there was a 5 log₁₀ or greater reduction in viability of S. aureus added to the surface 1 day after the addition of the disinfecting composition, which corresponds to a 99.99% to 99.999% reduction in bacterial load. A similar bactericidal effect was seen when adding S. aureus 7 days after dry-coating the surface with the disinfecting composition. At 14 days after dry-coating, there was a 4-6 log₁₀ reduction in viability of S. aureus. Concentrations of the disinfecting composition of 0.05 wt % or higher reduced the amount of S. aureus to levels below the limits of detection.

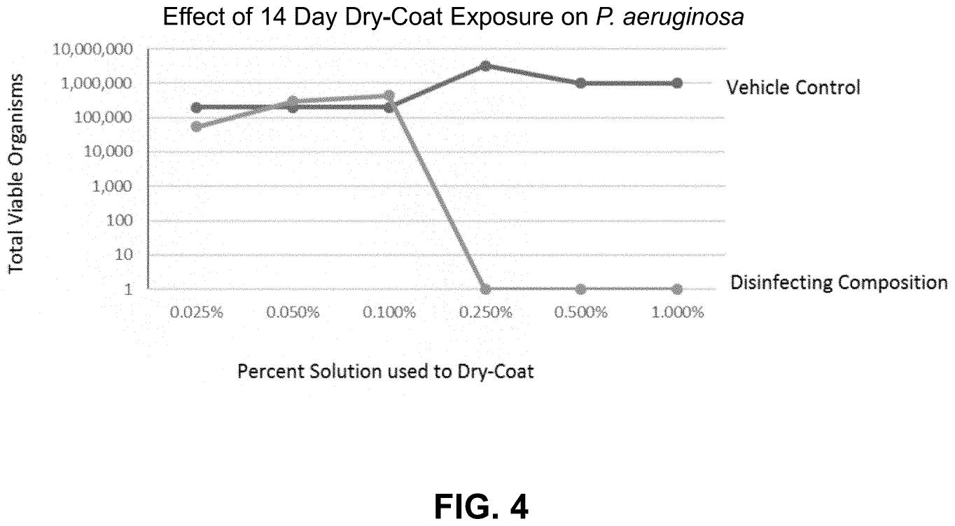

Regarding FIG. 4, the test results with respect to P. aeruginosa are shown after 14 days. The average amount of live bacteria from two technical replicate titrations of 2-3 biological/experimental replicates. Standard errors of the vehicle control means were less than 15%. When adding P. aeruginosa to surfaces dry-coated with the disinfecting composition for 7 or 14 days, there was a 5-6 log₁₀ reduction in viability with coating concentrations of 0.25 wt % or higher.

### Example 3

### Extended Dry-Coat Testing with C. difficile

Disinfecting compositions containing 4 wt % of N-chloro-4-carboxybenzenesulfonamide (BENZ), and a vehicle control solution were prepared. Approximately 5 mL of each solution was added to sterile non-hydrophobic tissue culture dishes, completely covering the surface, and allowed to evaporate and dry coat the plate surface overnight. After drying, the coated plates were stored at room temperature.

A total of 3 C. difficile strains were tested, designated as designated “Cd1”, “Cd2” and “Cd3” herein. The strains were isolated in U.S. hospitals and are part of a collection curated by the Centers for Disease Control and Prevention to represent the diversity of C. difficile strains circulating in the U.S. Cd1 is Isolate 20110870, PCR ribotype 027, containing the tcdA, B, and C genes of the PaLoc operon and the C. difficile binary toxin (CDT). Cd2 is Isolate 20120166, PCR ribotype 002, containing the tcdA, B, and C genes of the PaLoc operon and is negative for the C. difficile binary toxin (CDT). Cd3 is Isolate 20110963, PCR ribotype 017, containing the tcdA, B, and C genes of the PaLoc operon and is negative for the C. difficile binary toxin (CDT). Bacterial endospore solutions were added as 25 μl drops at several locations on each dish and allowed to dry. Swab samples of the plate areas containing dried spores were taken at 24 hours, 2 days, and 7 days after spore addition to the dry-coated plates. Spore solutions were counted microscopically and final concentrations ranged between 1×10⁹ to 1×10¹⁰ spores per ml.

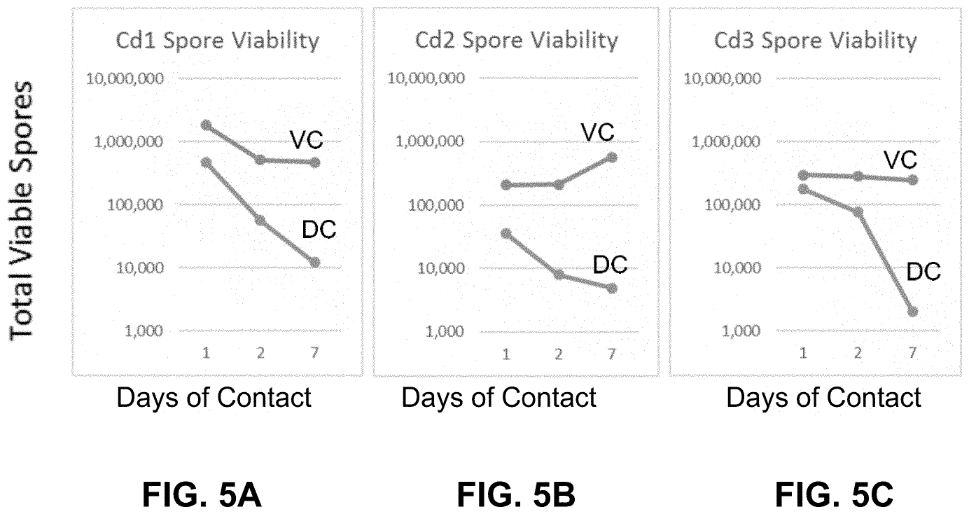

After each exposure time, dry endospore spots were swabbed from the coated plates and processed. Colony numbers of about 20 to 200 colonies were used to determine the total number of viable endospores after treatment. The results are shown in FIGS. 5A-5C.

Regarding FIGS. 5A, 5B, and 5C, the test results of the vehicle control are labeled “VC”, while the results from the disinfecting composition are labeled “DC”. Endospores from all three C. difficile strains displayed a reduced viability with extended exposure to the disinfecting composition. After a 7 day dry exposure, there was an about 2 log₁₀ (99%) reduction in viable spores from the 3 strains.

The present disclosure has been described with reference to exemplary embodiments. Modifications and alterations will occur to others upon reading and understanding the preceding detailed description. It is intended that the present disclosure be construed as including all such modifications and alterations insofar as they come within the scope of the appended claims or the equivalents thereof.

1. A dry coat-forming antimicrobial composition, comprising a halo active aromatic sulfonamide compound of Formula (I): 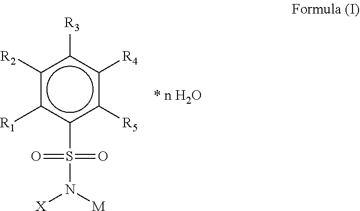
wherein R₁, R₂, R₃, R₄, and R₅ are independently selected from hydrogen, COOR′, CON(R″)₂, alkoxy, CN, NO₂, SO₃R″, halogen, substituted or unsubstituted phenyl, sulfonamide, halosulfonamide, N(R″)₂, substituted or unsubstituted C₁-C₁₂ alkyl, and substituted or unsubstituted aromatic;
R′ is hydrogen, an alkali metal, an alkaline earth metal, substituted C₁-C₁₂ alkyl, or unsubstituted C₁-C₁₂ alkyl; and
R″ is hydrogen or substituted or unsubstituted C₁-C₁₂ alkyl, where the two R″ groups in CON(R″)₂ and N(R″)₂ may be independently selected;
X is halogen;
M is an alkali or alkaline earth metal; and
n is the number of water molecules per molecule of the sulfonamide compound; and
wherein the antimicrobial composition forms a residual antimicrobial dry coating.

2. The composition of claim 1, wherein at least one of R₁, R₂, R₃, R₄, or R₅ is not hydrogen.

3. The composition of claim 1, wherein the halo active aromatic sulfonamide compound is chloramine-T or N-chloro-4-carboxybenzenesulfonamide.

4. The composition of claim 1, further comprising water.

5. The composition of claim 1, further comprising a buffering agent.

6. The composition of claim 5, wherein the buffering agent is present in a quantity sufficient to obtain a pH of about 6 to about 14 for the composition.

7. The composition of claim 5, wherein the buffering agent is present in a quantity sufficient to obtain a pH of 6 to about 10 for the composition.

8. The composition of claim 1, further comprising a surfactant.

9. The composition of claim 1, further comprising a tracer fragrance.

10. The composition of claim 1, wherein the halo active aromatic sulfonamide compound is present in the residual antimicrobial dry coating in an amount of 0.0001 wt % to about 100 wt %.

11. The composition of claim 1, wherein the halo active aromatic sulfonamide compound is present in the composition in an amount of about 0.0001 wt % to about 5 wt %.

12. A method of keeping a surface disinfected for over 24 hours, comprising:
applying an antimicrobial composition to the surface; and
forming an antimicrobial film from the antimicrobial composition;
wherein the antimicrobial film comprises a halo active aromatic sulfonamide compound of Formula (I): 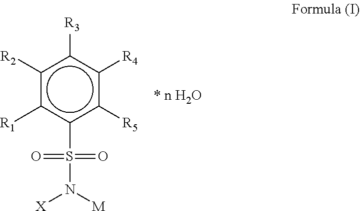
wherein R₁, R₂, R₃, R₄, and R₅ are independently selected from hydrogen, COOR′, CON(R″)₂, alkoxy, CN, NO₂, SO₃R″, halogen, substituted or unsubstituted phenyl, sulfonamide, halosulfonamide, N(R″)₂, substituted or unsubstituted C₁-C₁₂ alkyl, and substituted or unsubstituted aromatic;
R′ is hydrogen, an alkali metal, an alkaline earth metal, substituted C₁-C₁₂ alkyl, or unsubstituted C₁-C₁₂ alkyl; and
R″ is hydrogen or substituted or unsubstituted C₁-C₁₂ alkyl, where the two R″ groups in CON(R″)₂ and N(R″)₂ may be independently selected;
X is halogen;
M is an alkali or alkaline earth metal; and
n is the number of water molecules per molecule of the sulfonamide compound;

13. The method of claim 12, wherein the surface remains disinfected for over 336 hours.

14. The method of claim 12, wherein the halo active aromatic sulfonamide compound is chloramine-T or N-chloro-4-carboxybenzenesulfonamide.

15. The method of claim 12, wherein the composition is applied to the surface by spraying, electrostatic application, fogging, wipes, misting, or immersion.

16. The method of claim 12, wherein the composition maintains at least 98% killing performance after 168 hours.

17. The method of claim 12, wherein the antimicrobial film is formed by evaporation of water from the antimicrobial composition.

18. A dry coating comprising a halo active aromatic sulfonamide compound of Formula (I): 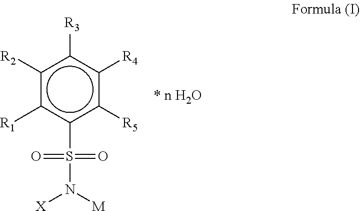
wherein R₁, R₂, R₃, R₄, and R₅ are independently selected from hydrogen, COOR′, CON(R″)₂, alkoxy, CN, NO₂, SO₃R″, halogen, substituted or unsubstituted phenyl, sulfonamide, halosulfonamide, N(R″)₂, substituted or unsubstituted C₁-C₁₂ alkyl, and substituted or unsubstituted aromatic;
R′ is hydrogen, an alkali metal, an alkaline earth metal, substituted C₁-C₁₂ alkyl, or unsubstituted C₁-C₁₂ alkyl; and
R″ is hydrogen or substituted or unsubstituted C₁-C₁₂ alkyl, where the two R″ groups in CON(R″)₂ and N(R″)₂ may be independently selected;
X is halogen;
M is an alkali or alkaline earth metal; and
n is the number of water molecules per molecule of the sulfonamide compound.

19. The dry coating of claim 18, wherein the halo active aromatic sulfonamide compound is present in the dry coating in an amount of about 0.0001 wt % to about 100 wt %.

20. The dry coating of claim 18, wherein the dry coating maintains at least 98% killing performance after 168 hours.

21. An article having an antimicrobial dry coating on a surface thereof, the dry coating comprising a halo active aromatic sulfonamide compound of Formula (I): 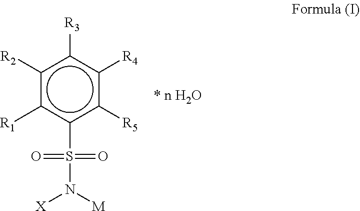
wherein R₁, R₂, R₃, R₄, and R₅ are independently selected from hydrogen, COOR′, CON(R″)₂, alkoxy, CN, NO₂, SO₃R″, halogen, substituted or unsubstituted phenyl, sulfonamide, halosulfonamide, N(R″)₂, substituted or unsubstituted C₁-C₁₂ alkyl, and substituted or unsubstituted aromatic;
R′ is hydrogen, an alkali metal, an alkaline earth metal, substituted C₁-C₁₂ alkyl, or unsubstituted C₁-C₁₂ alkyl; and
R″ is hydrogen or substituted or unsubstituted C₁-C₁₂ alkyl, where the two R″ groups in CON(R″)₂ and N(R″)₂ may be independently selected;
X is halogen;
M is an alkali or alkaline earth metal; and
n is the number of water molecules per molecule of the sulfonamide compound.

22. The article of claim 21, wherein the article is a trash bag.

23. The article of claim 22, wherein (A) the dry coating is on an inner surface of the trash bag or an outer surface of the trash bag, or (B) the trash bag is formed from a multi-layer film and the dry coating is located between two layers of the film.

24. The article of claim 21, wherein the halo active aromatic sulfonamide compound is chloramine-T or N-chloro-4-carboxybenzenesulfonamide.

25. The article of claim 21, wherein the halo active aromatic sulfonamide compound is present in the dry coating in an amount of 0.0001 wt % to about 100 wt %.
